(19) United States
(12) Patent Application Publication
(10) Pub. No.: US 2014/0012631 A1
(43) Pub. Date: Jan. 9, 2014

(54) COMPETITIVE ECONOMY AS A RANKING DEVICE OVER NETWORKS

(71) Applicant: Ramot at Tel-Aviv University Ltd., Tel Aviv (IL)

(72) Inventors: Ehud Lehrer, Tel Aviv (IL); Ady Pauzner, Tel Aviv (IL)

(21) Appl. No.: 13/932,078

(22) Filed: Jul. 1, 2013

Related U.S. Application Data
(60) Provisional application No. 61/667,436, filed on Jul. 3, 2012.

(51) Int. Cl. G06Q 30/02

(52) U.S. Cl. CPC G06Q 30/0206
USPC 705/7.35

(57) ABSTRACT

A method for processing information, includes constructing a directed graph including nodes corresponding to information sources and edges corresponding to links among the information sources. Respective equilibrium prices of the nodes are computed by modeling the directed graph as an exchange economy. A ranking of the information sources is generated responsively to the equilibrium prices of the corresponding nodes.

### CROSS-REFERENCE TO RELATED APPLICATION

This application claims the benefit of U.S. Provisional Patent Application 61/667,436, filed Jul. 3, 2012, which is incorporated herein by reference.

### FIELD OF THE INVENTION

The present invention relates generally to information systems, and specifically to ranking of sources of information.

### BACKGROUND

Given the huge and ever-expanding abundance of information available, in particular from on-line sources, ranking of the sources of information is an indispensable tool in enabling users to find the information most relevant to a particular topic. A given query to a search engine, for example, may return hundreds or thousands of results. Search engines typically rank the results that they present to the user according to some measure of relevance, and users generally review only the first page or two of results. Thus, an accurate ranking system can be crucial in ensuring that the user sees the results that are most likely to be of interest.

Some ranking tools that are known in the art use links between Web pages or other connections between information sources as the basis for ranking. Typically, information sources with larger numbers of links receive higher ranks. For example, Google® PageRank™ assigns a numerical weight to each document in a hyperlinked set depending on both the number and the weights of the other documents that point to it. As another example, citation indices rank publications (particularly scholarly publications) by the number of later publications that reference them, without taking into account the weights of those publications.

### SUMMARY

Embodiments of the present invention that are described hereinbelow provide improved methods for ranking information sources, as well as apparatus and software implementing such methods.

There is therefore provided, in accordance with an embodiment of the present invention, a method for processing information, which includes constructing a directed graph including nodes corresponding to information sources and edges corresponding to links among the information sources. Respective equilibrium prices of the nodes are computed by modeling the directed graph as an exchange economy. A ranking of the information sources is generated responsively to the equilibrium prices of the corresponding nodes.

In a disclosed embodiment, the information sources are Web pages, and the links are hyperlinks among the Web pages, and constructing the directed graph includes compiling a record of the Web pages and hyperlinks, and generating the graph based on the Web pages and hyperlinks in the record.

In some embodiments, computing the respective equilibrium prices includes assigning a utility function to the links originating from each information source, and computing an equilibrium of the prices using the utility function. The utility function may include a symmetric constant elasticity of substitution (CES) utility function. Typically, the CES utility function has an elasticity parameter, and assigning the utility function may include setting a value of the elasticity parameter so as to engender a specified prioritization of the links in generating the ranking.

In one embodiment, computing the respective equilibrium prices includes applying a redistributive taxation scheme to the prices so as to cause the information sources to be weighted according to the rankings in computing an equilibrium of the prices. Typically, applying the redistributive taxation scheme includes setting a taxation rate so as to adjust a relative weighting of the information sources.

Additionally or alternatively, computing the respective equilibrium prices includes predicting a bias in the prices due to an influence of the ranking on creation of the links between the information sources, and adjusting the equilibrium prices so as to cancel out the predicted bias. Adjusting the equilibrium prices may include applying a parameter representative of the bias in assigning a utility function to the links originating from each information source, and computing an equilibrium of the prices using the utility function.

In disclosed embodiments, the method includes presenting the information sources to a user in an order determined by the ranking.

There is also provided, in accordance with an embodiment of the present invention, apparatus for processing information, including a memory, which is configured to hold a record of information sources and links among the information sources. A processor is configured to construct a directed graph including nodes corresponding to the information sources and edges corresponding to the links among the information sources, to compute respective equilibrium prices of the nodes by modeling the directed graph as an exchange economy, and to generate a ranking of the information sources responsively to the equilibrium prices of the corresponding nodes.

There is additionally provided, in accordance with an embodiment of the present invention, a computer software product, including a non-transitory computer-readable medium in which program instructions are stored, which instructions, when read by a computer, cause the computer to access a record of information sources and links among the information sources, to construct a directed graph including nodes corresponding to the information sources and edges corresponding to the links among the information sources, to compute respective equilibrium prices of the nodes by modeling the directed graph as an exchange economy, and to generate a ranking of the information sources responsively to the equilibrium prices of the corresponding nodes.

There is further provided, in accordance with an embodiment of the present invention, a method for ranking sources of information, which includes constructing a directed graph including nodes corresponding to the sources of information and edges corresponding to links among the sources. Respective equilibrium prices of the nodes are computed by modeling the directed graph as an exchange economy. A ranking of the sources of information is generated responsively to the equilibrium prices of the corresponding nodes.

The method may optionally include placing a bid for one of the sources of the information using the ranking.

There is moreover provided, in accordance with an embodiment of the present invention, apparatus for ranking sources of information, including a memory, which is configured to hold a record of the sources of information and links among the sources. A processor is configured to construct a directed graph including nodes corresponding to the sources of information and edges corresponding to the links among the sources, to compute respective equilibrium prices of the nodes by modeling the directed graph as an exchange economy, and to generate a ranking of the sources of information responsively to the equilibrium prices of the corresponding nodes.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for information access, in accordance with an embodiment of the present invention;

FIG. 2 is a graph that schematically represents information sources and links therebetween, used in ranking the information sources in accordance with an embodiment of the present invention; and

FIG. 3 is a flow chart that schematically illustrates a method for ranking information sources, in accordance with an embodiment of the present invention.

### DETAILED DESCRIPTION OF EMBODIMENTS

Embodiments of the present invention that are described herein provide an improved method for ranking information sources, based on principles of economic analysis. More specifically, documents on a network are treated as consumers and as goods which are available for “exchange” between the consumers. Incoming links to any given document are treated as a measure of demand for the goods. Principles of price equilibrium in a competitive economy are then applied in order to compute a “price” for each document, which may be used as a ranking weight. Various utility functions may be used in the economy, giving different rankings to suit different needs.

Concepts from the various fields of economics may be used in order to further enrich the scope of applications. For example, adding a redistributive taxation scheme allows a controlled linkage between the rank of an item and its weight as a referee, since the level of the tax determines the dependence of the consumer's budget on the price of his good. In particular, an economy with a 100% tax yields a normalized version of the citation index. This sort of model can thus be used not only for ranking in contexts with a large degree of simultaneity of links, such as the World Wide Web, but also in contexts in which links tend to go in one direction (e.g., backwards in time), such as the academic citations arena. In this latter context, PageRank might fail to provide a satisfactory ranking, while the ranking system typically used is citation counting ignores the relative importance of citations. Embodiments of the present invention can overcome these limitations.

In the real world, the links between documents and their ranks are often biased: Agents who decide what to quote are influenced by published rankings. An embodiment of the present invention predicts the outcome of the interaction between the ranking system and such biased agents. In this embodiment, the ranking system can be modified so that the outcome of the modified ranking system, given biased agents, will be the same as the outcome that would have emerged if the intended ranking system were at work in a world in which agents were “sincere” and did not bias their links. The ranking scheme thus compensates for the inherent bias of the agents.

Further mathematical and theoretical details of these ranking schemes and methods for modeling and removing bias from rankings are presented in the above-mentioned U.S. Provisional Patent Application 61/667,436. Some of these details are omitted from the description that follows for the sake of simplicity.

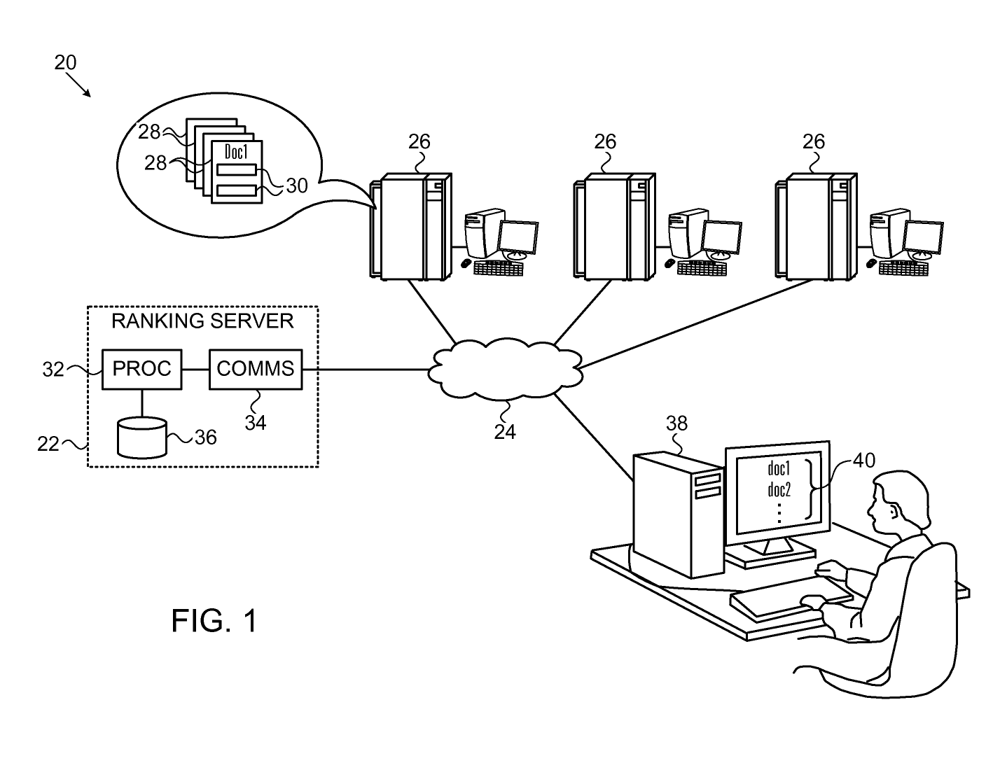

FIG. 1 is a block diagram that schematically illustrates a system 20 for information access, in accordance with an embodiment of the present invention. This system is shown as an example of the sort of environment in which the principles of the present invention may be applied for purposes of ranking information sources. A ranking server 22 collects information via a network 24 from multiple information servers 26 regarding documents 28 that they possess. These documents are the “information sources” in the present embodiment. For example, network 24 may be the Internet, servers 26 may be Web servers, and documents 28 may be Web pages. Documents 28 typically comprise links 30, in the form of hyperlinks to other such documents, which are processed by ranking server 22 in order to rank the documents, as described in detail herein.

Although the methods described in the present patent application are particularly useful in ranking Web pages and other sorts of hyperlinked documents in the context of system 20, the present invention is by no means limited to this particular environment. For example, the present methods may be adapted to rank publications according to citations in other publications, as in citation indices that are known in the art. As another example, the method may be used in bidding over the web for publishing and other sorts of rights and properties, as ranking that it provides can help a bidder in evaluate his or her own reservation price. (Such a bid may be composed manually by the bidder or automatically by server 22 or by another suitable processor.) More generally, the principles of the present invention may be applied in generating rankings of various other type of interlinked entities.

Ranking server 22 typically comprises a general-purpose computer processor 32 which is linked to network 24 by a suitable communications interface 34. Processor compiles and maintains a record of documents 28 and links 30 in a memory 36 and uses this record in generating the document rankings. For example, processor 32 may operate a Web crawler, as is known in the art, to crawl over the Web pages held by servers 26 and collect the necessary information. Typically, processor 32 is programmed in software to carry out the functions that are described herein. This software may be downloaded to server 22 in electronic form, over a network, for example. Additionally or alternatively, the software may be stored on non-transitory, computer-readable media, such as optical, magnetic, or electronic memory media.

The rankings developed by server 22 may be used for various purposes. For example, these rankings may be applied in conjunction with a search engine, in order to determine the order in which selected documents 28 are presented to a user in response to a query. Thus, in the pictured embodiment, a client computer 38 submits a query to a search engine (which may run on server 22 or on some other computer), and in return receives and displays an ordered list 40 of relevant documents.

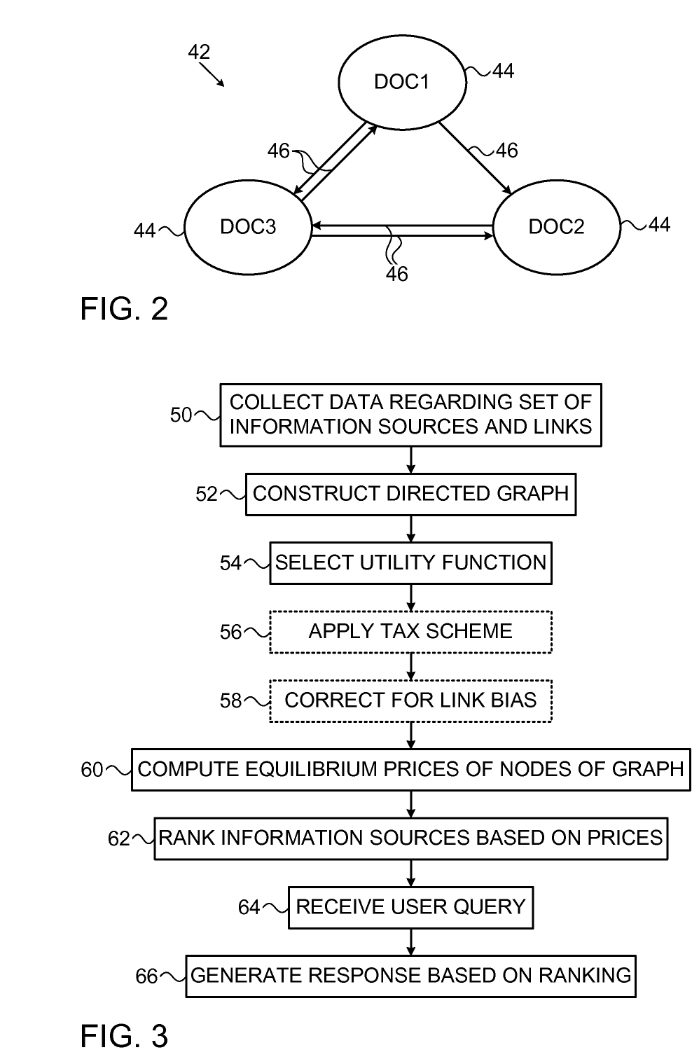

FIG. 2 is a directed graph 42 that schematically represents information sources and links therebetween, used by server 22 in ranking documents 28 in accordance with an embodiment of the present invention. For clarity of illustration, this highly-simplified example involves only three documents, whereas Web applications, for example, may involve many thousands of documents. Each document 28 is represented by a corresponding node 44 in the graph. The nodes are interconnected by directed edges 46, corresponding to links between the documents. In the pictured example, one of the documents (DOC3) has links both to and from the other two documents (DOC1 and DOC2). On the other hand, DOC1 contains a link to DOC2, but DOC2 has no link to DOC1.

Formally stated, server 22 generates a directed graph G, in which each node 44 (vertex) in V={1, . . . , n} represents a document, and each directed edge (i,j)εE⊂V x V represents a link from document i to document j. Let O(i)={j:(i,j)εE} be the set of nodes to which i has a link, i.e., the set of outgoing links from i; and let I(i)={j:(j,i)εE} be the set of nodes sending links to i (i.e., incoming links from j). For the sake of simplicity we assume that every site sends links, and that there are no self-links. A ranking system is a function from such directed graphs to vectors of valuations, wherein the vector comprises one coordinate (the ranking value) for each node.

FIG. 3 is a flow chart that schematically illustrates a method for ranking information sources, in accordance with an embodiment of the present invention. For the sake of clarity, the method is described hereinbelow with reference to the elements of system 20 (FIG. 1) and simplified graph 42 (FIG. 2). As noted earlier, however, the principles of this method may similar be applied to substantially any set of interlinked information sources in various different system configurations.

Initially, server 22 collects data regarding the set of information sources and the links between them documents 28 and links 30 in the present example—in a data collection step 50. The data are typically updated periodically, and the rankings updated accordingly. Server 22 then constructs a directed graph, such as graph 42, based on the collected data, at a graph construction step 52.

Server 22 models this graph as an exchange economy. The economy includes n consumers, one for each node 44. There are also n goods, and consumer i has an initial endowment of one unit of good i. The utility of consumer (as defined below) depends on the qualities of goods he consumes {xⱼ:jεO(i)}, i.e., the goods that correspond to the vertices to which this consumer has links. Consumer i does not consume any goods other than these (including his own goods).

Server 22 selects a utility function to apply in ranking the information sources, at a function selection step 54. The utility function of the consumers in the exchange economy model applied to graph 42 is a vector u=(u¹, u², . . . , uⁿ), wherein u^{k}: [symbol] ^{k}₊→ [symbol] is the utility function of a consumer who has k links and is therefore able to consume k goods (k=1, . . . , n). It is required that for every k, u^{k} be a symmetric function, i.e., u^{k}(x)=u^{k}(π(x)) for any k-vector of goods x and any permutation π of k elements. Symmetry implies that the contribution to the utility of the goods consumed depends only on their quantities and not on their identity. Thus, any difference between items in their induced ranking stems only from the structure of the links and is not imposed by the utility function.

A wide variety of utility functions are known in the art of economics, and many of them may be adapted for use in the context of the present method. As one example, a Cobb-Douglas utility function may be used and, when applied in the present, gives rankings equivalent to those of the Google PageRank algorithm. This possible approach is described in detail in the above-mentioned provisional patent application.

As another example, server 22 may apply a symmetric constant elasticity of substitution (CES) utility function, of the type described by Arrow et al., in “Capital-Labor Substitution and Economic Efficiency,” Review of Economics and Statistics 43, pages 225-250 (1961). Such utility functions have the general form:

$${u}_{i} ( x , β ) = {( {\sum }_{j ∈ O ( i )} {x}_{j}^{β} )}^{\frac{1}{β}} wherein β ∈ [ - ∞ , 1 ] \qquad ( 1 )$$

The variable parameter β can be referred to as an “elasticity parameter,” as it reflects the elasticity of substitution between different goods (or equivalently, different information sources in the present case). In other words, the value of the elasticity parameters determines the effect (positive or negative) that the ranking value of a given node will have on the rankings of other nodes that are linked to it. Thus, the value chosen for the elasticity parameter will engender a certain prioritization of links 46 in generating the ranking of nodes 44. Different choices of the parameter will change the cardinal rankings of the nodes and may change their ordinal rankings, as well.

Ranking systems induced by an exchange economy equate, by definition, the refereeing power of an information source with its quality (its rank). The reason for this characteristic is that the price of good i, which is identified as its rank, becomes the budget of consumer i. This budget is then split between the other documents to which information source i extends links, and thus is exactly equal to the refereeing power of i.

This sort of distribution of refereeing power is not consistent with some ranking schemes that are known in the art. For example, the Science Citation Index (SCI) disregards completely the rank of an article in determining its refereeing power: In the SCI a citation from any article has the same importance. In another scheme, the weight of a citation from an article may be independent of its rank, but decreases with the number of citations that article makes.

Optionally, to engender this sort of ranking behavior, server 22 may apply a “taxation” scheme in the economic model that is used to rank the information sources, in a taxation step 56. The tax can be used to control the extent to which the price of good i and the budget of consumer i are tied together. Specifically, the taxation scheme requires every consumer to “pay” a fraction α of his “income” as a tax, and returns 1/n of the total tax revenue as a lump sum transfer to each consumer. With a 100% tax rate, the reviewing power of all information sources is equal, regardless of their ranking, because all have the same budget (1/n of the tax revenue). By fixing a lower tax rate, server 22 may control the extent to which the reviewing power and the ranking of an information source are entangled or disentangled.

In reality, the decisions of agents (typically human beings) who create documents 28 regarding links 30 that they insert to other documents are often biased by the ranking system itself: The fact that a document is highly ranked makes agents more likely to cite it, thus further increasing the number of links the document receives, pushing its rank even higher. Optionally, server 22 may still model this sort of scenario as an exchange economy (with unbiased agents), according to the present method, by predicting the bias in the prices of documents 28 that would arise due to the influence of the ranking on creation of the links between the documents, and adjusting the equilibrium prices so as to cancel out the predicted bias, at a bias cancellation step 58.

In order to model the effect of biased agents, it is useful to consider the utility function of equation (1) above in terms of the alternative elasticity parameter r=β/1−β. In the above-mentioned provisional application, it is shown that when agent bias is taken into account, and equilibrium prices are computed using this modified model of the exchange economy, the resulting prices assigned to nodes 44 (and hence to documents 28) will be the same as if the equilibrium were computed in the original, unbiased model using a CES utility function with the alternative elasticity parameter r′=r+b, wherein b is a parameter representing the bias. For linear bias (i.e., link utility that increases linearly with the ranking of the node to which the link is directed), b=1.

Therefore, to cancel the predicted bias at step 58, server 22 may modify the desired utility function by adjusting the elasticity parameter to account for the expected bias. If the expected bias is linear, for example, and the desired elasticity is represented by r′, then server 22 will use a CES utility function with the alternative elasticity parameter r′=r−1. The parameter β may be adjusted accordingly.

After choosing the appropriate utility function at step 54 (and associated corrective parameters at steps 56 and 58 if desired), server 22 computes equilibrium prices of nodes 44 in graph 42, at an equilibrium computation step 60. This computation is based on principles of competitive price equilibrium and computation of such equilibria that are known in the art of economics: The price of each node increases or decreases according to the demand for the good associated with the node, as expressed by the utility functions and buying power of the neighboring nodes; and concurrently the buying power of the node as a consumer is given by (and changes with) its price, and thus influences the prices of the neighboring nodes. The equilibrium is constrained in that aggregate demand for any good cannot exceed the aggregate supply of the good, and consumers must generally choose, among all the baskets of goods that they can afford, the one that maximizes their utility.

In practice, the inventors have found it advantageous to relax the latter requirement (that consumers must choose among the goods they can afford), so that it applies only to those consumers (nodes 44) that have a positive budget, i.e., whose price pᵢ is greater than zero at the equilibrium. Consumers whose budget is worth zero do not maximize their utility and consume only “leftovers” of the goods associated with nodes to which they are linked. The result is a quasi-equilibrium of prices, as defined by Debreu in “New Concepts and Techniques for Equilibrium Analysis,” International Economic Review 3, pages 257-273 (1962).

Formally, quasi-equilibrium in the exchange economy induced by the graph G is a tuple (x₁, x₂, . . . , xₙ; p), wherein xᵢ=(xᵢ^{j})_{jεO(i)}ε [symbol] ⁽ⁱ⁾ is the basket of goods consumed by consumer i (in which c(i) is the cardinality of i), and p is a non-zero vector in [symbol] ⁿ₊ such that:

(1) For every consumer i with pᵢ>0, if yᵢε [symbol] ⁽ⁱ⁾ and u^{c(i)}(yᵢ)>u^{c(i)}(xᵢ), then p·yᵢ>pᵢ.

(2) For every good j, Σ_{ijεO(i)}xᵢ^{j}=1.

The expression p·yᵢ represents the value of the basket yᵢ. The price-vector p is called a quasi-equilibrium price system (or a vector of quasi-equilibrium prices) and is computed, using methods that are known in the art, so as to maximize the utility functions of the consumers.

Server 22 ranks documents 28 according to the quasi-equilibrium prices of the corresponding nodes 44, at a ranking step 62. Thus, if p=(p₁, . . . , pₙ)ε [symbol] ⁿ₊ is the vector of quasi-equilibrium prices, then the rank of node i is given by the price of the corresponding good pᵢ. Choice of an appropriate utility function, such as the CES utility defined above, will guarantee a unique equilibrium and therefore a unique ranking.

The ranking developed at step 62 may be used for various purposes. For example, it may be used in ranking search results, in a manner analogous to Google PageRank, but with greater versatility in choosing the criteria according to which documents are to be ranked—depending on the choice of the utility function and its parameters. In this sort of embodiment, server 22 may function as a search engine or be coupled to add rankings to search results returned by a search engine. A user, such as the user of computer 38, submits a search query to server 22, at a query step 64. Server 22 responds by generating and returning a list of documents 28, at a response step 66. The ranking of the documents in the response is based, at least in part, on the price-based ranking found at step 62.

This particular use of the methods of ranking described above is just one example, and other applications of the sorts of ranking schemes that can be computed using these methods will be apparent to those skilled in the art and are considered to be within the scope of the present invention. It will thus be appreciated that the embodiments described herein are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for processing information, comprising:
constructing a directed graph comprising nodes corresponding to information sources and edges corresponding to links among the information sources;
computing respective equilibrium prices of the nodes by modeling the directed graph as an exchange economy; and
generating a ranking of the information sources responsively to the equilibrium prices of the corresponding nodes.

2. The method according to claim 1, wherein the information sources are Web pages, and the links are hyperlinks among the Web pages, and wherein constructing the directed graph comprises compiling a record of the Web pages and hyperlinks, and generating the graph based on the Web pages and hyperlinks in the record.

3. The method according to claim 1, wherein computing the respective equilibrium prices comprises assigning a utility function to the links originating from each information source, and computing an equilibrium of the prices using the utility function.

4. The method according to claim 3, wherein the utility function comprises a symmetric constant elasticity of substitution (CES) utility function.

5. The method according to claim 4, wherein the CES utility function has an elasticity parameter, and wherein assigning the utility function comprises setting a value of the elasticity parameter so as to engender a specified prioritization of the links in generating the ranking.

6. The method according to claim 1, wherein computing the respective equilibrium prices comprises applying a redistributive taxation scheme to the prices so as to cause the information sources to be weighted according to the rankings in computing an equilibrium of the prices.

7. The method according to claim 6, wherein applying the redistributive taxation scheme comprises setting a taxation rate so as to adjust a relative weighting of the information sources.

8. The method according to claim 1, wherein computing the respective equilibrium prices comprises predicting a bias in the prices due to an influence of the ranking on creation of the links between the information sources, and adjusting the equilibrium prices so as to cancel out the predicted bias.

9. The method according to claim 8, wherein adjusting the equilibrium prices comprises applying a parameter representative of the bias in assigning a utility function to the links originating from each information source, and computing an equilibrium of the prices using the utility function.

10. The method according to claim 1, and comprising presenting the information sources to a user in an order determined by the ranking.

11. Apparatus for processing information, comprising:
a memory, which is configured to hold a record of information sources and links among the information sources; and
a processor, which is configured to construct a directed graph comprising nodes corresponding to the information sources and edges corresponding to the links among the information sources, to compute respective equilibrium prices of the nodes by modeling the directed graph as an exchange economy, and to generate a ranking of the information sources responsively to the equilibrium prices of the corresponding nodes.

12. The apparatus according to claim 11, wherein the information sources are Web pages, and the links are hyperlinks among the Web pages, and wherein the processor is configured to compile a record of the Web pages and hyperlinks, and to generate the graph based on the Web pages and hyperlinks in the record.

13. The apparatus according to claim 11, wherein the processor is configured to assign a utility function to the links originating from each information source, and to compute an equilibrium of the prices using the utility function.

14. The apparatus according to claim 13, wherein the utility function comprises a symmetric constant elasticity of substitution (CES) utility function.

15. The apparatus according to claim 14, wherein the CES utility function has an elasticity parameter, having a value that is set so as to engender a specified prioritization of the links in generating the ranking.

16. The apparatus according to claim 11, wherein the processor is configured to apply a redistributive taxation scheme to the prices so as to cause the information sources to be weighted according to the rankings in computing an equilibrium of the prices.

17. The apparatus according to claim 16, wherein the redistributive taxation scheme comprises has a taxation rate that is set so as to adjust a relative weighting of the information sources.

18. The apparatus according to claim 11, wherein the processor is configured to compute the respective equilibrium prices so as to cancel out a bias that is predicted in the prices due to an influence of the ranking on creation of the links between the information sources.

19. The apparatus according to claim 8, wherein the processor is configured to cancel out the bias by applying a parameter representative of the bias in assigning a utility function to the links originating from each information source.

20. A computer software product, comprising a non-transitory computer-readable medium in which program instructions are stored, which instructions, when read by a computer, cause the computer to access a record of information sources and links among the information sources, to construct a directed graph comprising nodes corresponding to the information sources and edges corresponding to the links among the information sources, to compute respective equilibrium prices of the nodes by modeling the directed graph as an exchange economy, and to generate a ranking of the information sources responsively to the equilibrium prices of the corresponding nodes.

21. A method for ranking sources of information, comprising:
constructing a directed graph comprising nodes corresponding to the sources of information and edges corresponding to links among the sources;
computing respective equilibrium prices of the nodes by modeling the directed graph as an exchange economy; and
generating a ranking of the sources of information responsively to the equilibrium prices of the corresponding nodes.

22. The method according to claim 21, and comprising placing a bid for one of the sources of the information using the ranking.

23. Apparatus for ranking sources of information, comprising:
a memory, which is configured to hold a record of the sources of information and links among the sources; and
a processor, which is configured to construct a directed graph comprising nodes corresponding to the sources of information and edges corresponding to the links among the sources, to compute respective equilibrium prices of the nodes by modeling the directed graph as an exchange economy, and to generate a ranking of the sources of information responsively to the equilibrium prices of the corresponding nodes.

24. The apparatus according to claim 23, wherein the processor is configured to generate a bid for one of the sources of the information using the ranking.
